(19) United States
(12) Patent Application Publication
(10) Pub. No.: US 2013/0248594 A1
(43) Pub. Date: Sep. 26, 2013

(54) MULTI-FUNCTION, INTERACTIVE PAYMENT CARD

(71) Applicant: Sunit SOOM, Carmel, NY (US)

(72) Inventor: Sunit SOOM, Carmel, NY (US)

(21) Appl. No.: 13/848,469

(22) Filed: Mar. 21, 2013

Related U.S. Application Data
(60) Provisional application No. 61/613,554, filed on Mar. 21, 2012.

(51) Int. Cl. G06Q 20/34; G06K 19/077

(52) U.S. Cl. CPC G06Q 20/3572; G06K 19/07707
USPC 235/380; 235/492

(57) ABSTRACT

The invention relates to a payment card apparatus with an onboard memory, reconfigurable magnetic strip, software suite, and touch screen for interacting with the data stored on said memory. A user is able to replace a plurality of conventional payment cards and card accounts by loading the relevant payment card data onto said memory and using a graphic user interface to select a desired payment card via the touch screen. The card then reconfigures the magnetic strip, allowing a single payment card apparatus to function as conventional payment card for multiple card accounts.

### CROSS REFERENCE TO RELATED APPLICATIONS

This application claims priority to U.S. Provisional Patent Application Ser. No. 61/613,554 filed on Mar. 21, 2012, titled “MULTI-FUNCTION, INTERACTIVE PAYMENT CARD”. The contents of the above-identified Application are relied upon and incorporated herein by reference in their entirety.

### FIELD OF INVENTION

The invention relates to a payment apparatus with a memory for storing multiple accounts on a single device and a touch screen with accompanying software for accessing said accounts, allowing a single card payment apparatus to replace a plurality of payment apparatus in everyday use.

### BACKGROUND OF INVENTION

There is a need for a solution to the growing number of payment cards a shopper commonly carries with them. The modern consumer is likely to carry multiple payment cards in their wallet or purse. These cards are often useful in specific locations (such as rewards cards for supermarkets, wholesale member cards, gift cards, and the like) or are redundant (carrying more than one credit card, the reasons for which there are many). As the number of cards carried by a consumer increases, the payment process becomes more cumbersome. Upon executing a purchase, the consumer must sift through all of the cards in their wallet or purse to find the desired card. Should a consumer wish to pare down the number of cards they carry, they risk ending up at a transaction without the proper card either through forgetfulness or misplacement of the card. Further, cards intentionally left at home in an effort to reduce the clutter associated with carrying too many cards could lead to spur of the moment purchases not receiving the benefit of the card. Those consumers that do carry all their cards are then burdened with bulky wallets and purses, which may lead to discomfort while performing the simplest of tasks.

What is envisioned, then, is an apparatus for allowing a user to consolidate multiple payment accounts onto a single payment device, eliminating the need to carry more than one wallet or purse.

### BRIEF DESCRIPTION OF FIGURES

The features of the invention believed to be novel and the elements characteristic of the invention are set forth with particularity in the claims. The figures are for illustration purposes only. The invention itself, however, both as to organization and method of operation, may be understood by reference to the detailed description which follows taken in conjunction with the accompanying drawings in which the drawings show typical embodiments of the invention and are not intended to be limited of its scope.

FIG. 1a depicts a payment apparatus consistent with one of the embodiments of the present.

FIG. 1b depicts the front of the payment apparatus of FIG. 1 wherein a card account has been selected by a user.

FIG. 2 depicts the back of the payment apparatus of FIG. 1.

FIG. 3 depicts the back of the payment apparatus of FIG. 1 wherein a card account has been selected by a user.

FIG. 4 depicts a method of making a purchase with the payment apparatus as depicted in FIG. 1.

FIG. 5 depicts a further embodiment of the method depicted in FIG. 4.

### DETAILED DESCRIPTION OF DRAWINGS

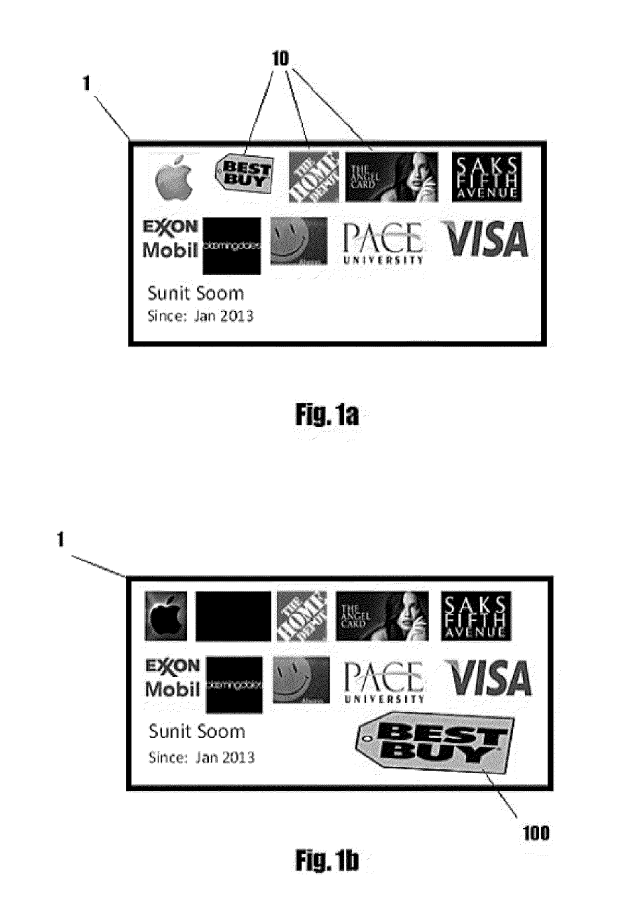

In describing the various embodiments of the instant invention, reference will be made herein to FIGS. 1-5 in which like numerals refer to like features of the invention.

In one embodiment, the apparatus comprises a memory, software executing on said apparatus for managing payment card information and facilitating transactions, at least one display, such as a touch screen, and a magnetic strip. In this embodiment, the apparatus is a wafer or card generally the size and thickness of a traditional credit card. The memory in the apparatus comprises databases comprising any information about the user's various payment accounts, such as credit cards, debit cards, charge cards, gift cards, and the like, hereinafter referred to as “card accounts”. Payment card information connected to said card accounts can include account numbers, card numbers, security pins, expiration dates, and general identification information, such as where the card is redeemable or usable and a representative image of the card. The memory also stores the software executing on said apparatus. In one embodiment, the software allows a user to access and interact with the card accounts and payment card information, such as through a graphic user interface. In another embodiment, the software allows wired or wireless updates to card accounts and payment card information stored in the memory, either through USB, Bluetooth, Wi-Fi, 3G/4G, RFD, and the like, such as through the use of an update module comprising the necessary hard and software components to manipulate the contents of said databases. It is also envisioned the apparatus comprises a wireless connectivity that allows for remote erasure of all information in the memory, such as in the event the device is misplaced or stolen. Such functionality allows for enhanced security. Additionally, since multiple card accounts are consolidated on a single apparatus accessible using a single service, a user of the apparatus desiring to cancel multiple card accounts need only make a request to the service provider associated with the apparatus, rather than making individual cancellation requests to multiple card service providers.

The at least one display is selected from the group consisting of a capacitive touch screen, a resistive touch screen, a piezoelectric touch screen, and the like. In one embodiment, the software executing on the apparatus comprises a graphic user interface portraying payment card information on the touch screens and allowing a user to view and interact with said card accounts and payment card information. Any screens on the device have inactive and active states. In an inactive state, the device is not displaying any information and does not allow interaction with the software or payment information held on the memory. In an active state, the user is either able to interact with the software or view payment information on the at least one screen. In one embodiment, if the user does not interact with the device for a certain period of time, the device returns to an inactive state. In one embodiment, said certain period of time is 60 seconds, but may vary.

In another embodiment, the information displayed to a user further comprises commercial information. Participating companies or retail locations can include advertisements as part of the user interaction experience. In one embodiment, when a user selects a department store charge card using the front mounted touch screen, the rear mounted touch screen displays the payment card information for that retail location, as well as an advertisement for certain sale items at that retail location. In a further embodiment, the device displays commercial information, such as advertisements, while in its inactive state. In an additional embodiment, the device is location aware, and can display commercial information to the user in its active or inactive state based on the location of the device, such as through the use of a global positioning system. For example, upon entering a retail location, the device will recognize that the user just entered a location for which the user had a preloaded gift card of a certain amount. The device then begins displaying relevant information about merchandise for sale in the store, such as the deals that would take the best advantage of the gift card.

Referring to FIG. 1a, in one embodiment, payment apparatus of the instant invention is a card 1 approximately or exactly the dimensions of a conventional credit card. The front face of card 1 comprises at least one screen. In some embodiments, the at least one screen covers substantially all of the face of card 1. In other embodiments, the at least one screen is supplemented by other screens. In this embodiment, the size of said multiple screens may be smaller and each screen may be activated independently of the other or at the same time. This added flexibility has the advantage of improved energy efficiency, especially when only displaying a small amount of information, as unused screen real estate may be left in an “off” position when not in use.

Software executing on an internal memory structure provides a graphic user interface, giving access to the card accounts also stored on said memory. In one embodiment, card accounts are displayed as representative images 10 on the screen on the face of card 1. If the screen is a touch screen, a user uses touch gestures to select the representative image 10 connected to the card account they wish to use. In some embodiments, such as shown in FIG. 1b, selection of a representative image 10 results in changes to the graphic user interface such as the appearance of an enlarged representative image 100 in another location on the screen. In other embodiments, the user may also use touch screen gestures to scroll through lists of card accounts, allowing for more card accounts to be loaded on said apparatus than can fit on said touch screen at any one time.

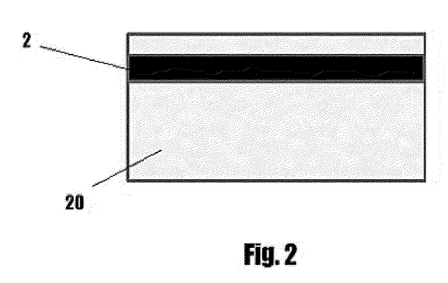

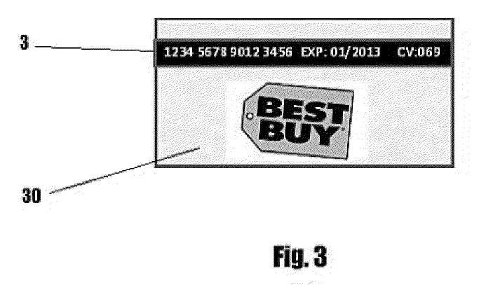

In some embodiments, selection of a representative image 10 on card 1 causes a reconfiguration on back side of card 1, as shown in FIG. 2. In one embodiment, selection of a representative image 10 on card 1 causes a reconfiguration of magnetic strip 2. The reconfiguration of magnetic strip 2 can be accomplished by any means, so long as conventional card readers such as those found at most points of sale would be able to scan the reconfigured magnetic strip to obtain the desired card information. In other embodiments, the back side of card 1 further comprises at least one screen 20. In some embodiments, such as the embodiment shown in FIG. 3, selection of a representative image causes a rear screen 30 to display a larger representative image to remind the user which card account was selected. The back side of card 1 also displays the relevant payment card information. In some embodiments, the user selects what information they would like the rear mounted screen to display. In one embodiment, the rear mounted screen displays a representative image, such as a logo, of the card, along with the card number, security code, and expiration date.

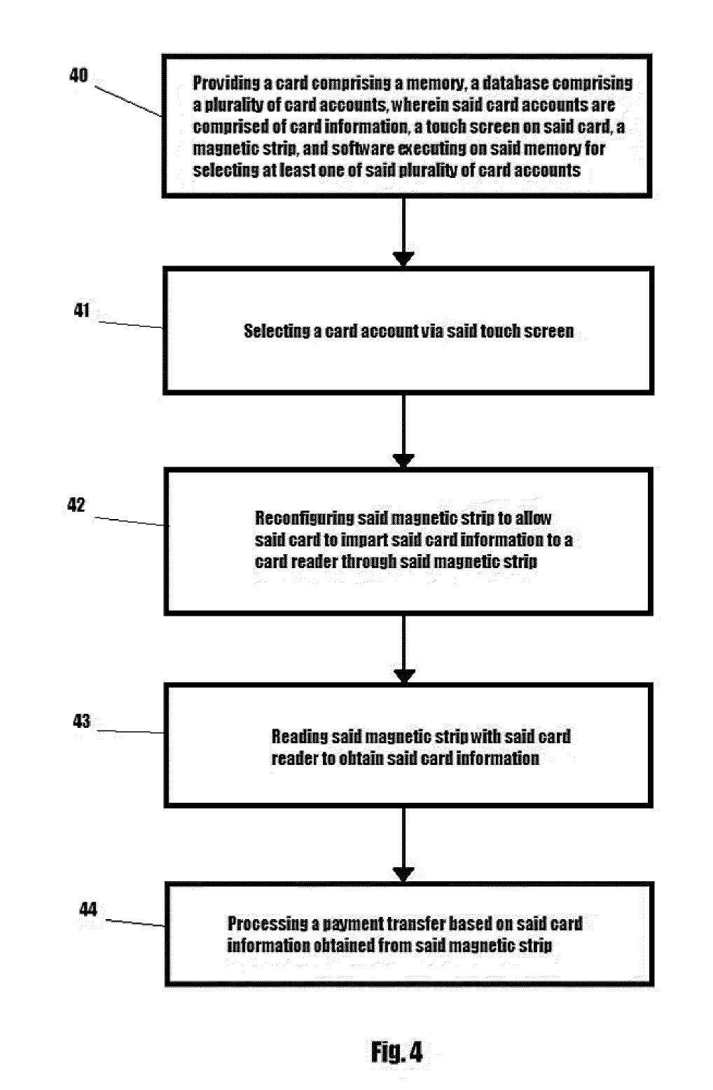

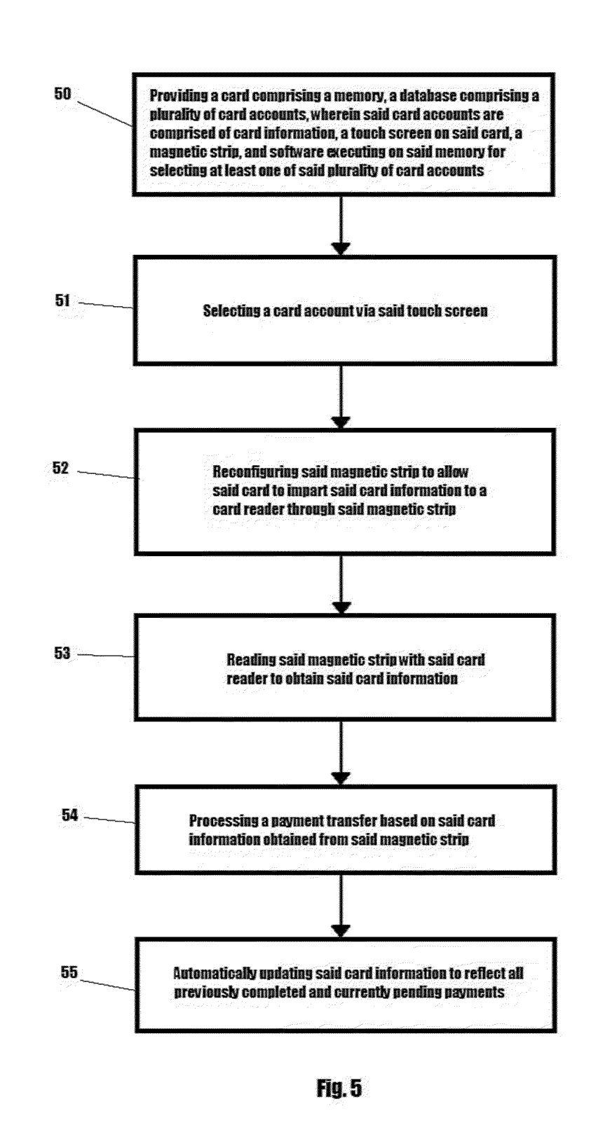

FIG. 4 portrays an embodiment of a method of making a purchase consistent with the instant invention using the above-described payment apparatus. Specifically, FIG. 4 portrays an embodiment comprising the steps of providing 40 a card comprising a memory, a database comprising a plurality of card accounts, wherein said card accounts are comprised of card information, a touch screen on said card, a magnetic strip, and software executing on said memory for selecting at least one of said plurality of card accounts, selecting 41 a card account via said touch screen, reconfiguring 42 said magnetic strip to allow said card to impart said card information to a card reader through said magnetic strip, reading 43 said magnetic strip with said card reader to obtain said card information, and processing 44 a payment transfer based on said card information obtained from said magnetic strip. In a further embodiment as shown in FIG. 5, the method also includes the step of automatically updating 55 said card information to reflect all previously completed and currently pending payments.

While the present invention has been particularly described, it is evident that many alternatives, modifications and variations will be apparent to those skilled in the art in light of the foregoing description. It is therefore contemplated that the appended claims will embrace any such alternatives, modifications, and variations as falling within the true scope and spirit of the present invention.

What is claimed is:

1. A payment apparatus comprising:
a card;
a memory;
a database of card accounts on said memory, said card accounts comprising payment card information for completing a transaction related to said card account;
at least one screen disposed on said card;
a magnetic strip disposed on said card;
software executing on said memory, wherein said software comprises a graphic user interface for displaying said payment card information on said at least one screen;
software executing on said memory for selecting a card account based on a selection from a user; and
software executing on said memory for reconfiguring said magnetic strip to impart said payment card information to a card reader.

2. A payment apparatus according to claim 1, wherein the screen is selected from the group consisting of: a capacitive touch screen, a resistive touch screen, and a piezoelectric touch screen.

3. A payment apparatus according to claim 1 further comprising a second screen disposed on said card.

4. A payment apparatus according to claim 1 further comprising a global positioning system.

5. The payment apparatus of claim 1 further comprising an update module allowing a user to selectively add or remove said payment card information from said first database.

6. The payment apparatus of claim 5, wherein said update module further comprises:
a wireless data processor;
software executing on said memory for transferring payment card data between said database and a computer readable media via a wireless data transfer.

7. The payment apparatus of claim 6 wherein said wireless data transfer is selected from the group consisting of: Bluetooth, RFID, Wi-Fi, and the like.

8. The payment apparatus of claim 1, further comprising software executing on said memory for remotely deleting said payment card information from said database.

9. The payment apparatus of claim 1, wherein the payment card information comprises account numbers, card numbers, security pins, expiration dates, general identification information and magnetic strip encoding instructions.

10. The payment apparatus of claim 4 further comprising software for recognizing a current location of the apparatus based and automatically displaying at least one card account relevant to said current location.

11. A method of making a payment comprising the steps of:
providing a card comprising a memory, a database comprising a plurality of card accounts, wherein said card accounts are comprised of card information, a touch screen on said card, a magnetic strip, and software executing on said memory for selecting at least one of said plurality of card accounts;
selecting a card account via said touch screen;
reconfiguring said magnetic strip to allow said card to impart said card information to a card reader through said magnetic strip;
reading said magnetic strip with said card reader to obtain said card information; and
processing a payment transfer based on said card information obtained from said magnetic strip.

12. The method of making a payment according to claim 11, further comprising the step of automatically updating said card information to reflect all previously completed and currently pending payments.
